(19) United States
(12) Patent Application Publication
(10) Pub. No.: US 2026/0092645 A1
(43) Pub. Date: Apr. 2, 2026

(54) GEAR STAGE SELECTION DEVICE FOR SELECTING GEAR STAGES OF A MOTOR VEHICLE TRANSMISSION

(71) Applicant: Dr. Ing. h.c. F. Porsche Aktiengesellschaft, Stuttgart (DE)

(72) Inventor: Thomas Breitinger, Rutesheim (DE)

(73) Assignee: Dr. Ing. h.c. F. Porsche Aktiengesellschaft, Stuttgart (DE)

(21) Appl. No.: 19/315,916

(22) Filed: Sep. 2, 2025

(30) Foreign Application Priority Data
Aug. 30, 2024 (DE) 102024124792.4

(51) Int. Cl. F16H 59/02; F16H 59/04; F16H 59/10; F16H 61/24

(52) U.S. Cl. CPC F16H 59/0204; F16H 59/044; F16H 59/105; F16H 61/24; F16H 2061/241

(57) ABSTRACT

A gear stage selection device for selecting gear stages of a motor vehicle transmission. The device includes a shaft, an axially displaceable slider apparatus, and a selection lever. The selection lever is coupled to the shaft and the slider apparatus in such a way that, in the case of a forward movement of the selection lever or in the case of a reverse movement of the selection lever, the shaft is twisted. In the case of a left movement of the selection lever or a right movement of the selection lever, the slider apparatus is axially displaced. A rotation angle sensor detects a rotation angle of the shaft. A position sensor detects an axial position of the slider apparatus. A blocking apparatus by way of which an axial displacement of the slider apparatus can be selectively mechanically blocked and released.

### CROSS-REFERENCE TO RELATED APPLICATION

This application claims priority to German Patent Application No. 10 2024 124 792.4, filed Aug. 30, 2024, which is incorporated by reference herein in its entirety.

### FIELD OF INVENTION

The present invention relates to a gear stage selection device for selecting gear stages of a motor vehicle transmission, in particular a motor vehicle transmission having a shift-by-wire system.

### BACKGROUND OF THE INVENTION

In the present case, gear stages include both automatic gear stages, for example “Drive” (D), “Neutral” (N), and “Reverse” (R), as well as transmission shifting stages, i.e., set gears of a transmission.

From DE 10 2017 114 591 A1, which is incorporated by reference herein, a gear stage selection device of the type mentioned above is known, which is configured so as to be operated in both an automatic operating mode as well as in an H-bridge operating mode. In the automatic operating mode, the known automatic gear stages (D, N, R, . . . ) can be adjusted by forward movement and reverse movement of a selection lever. In the H-bridge operating mode, gear shift stages, i.e., gears of the motor vehicle transmission, can be directly adjusted by forward movement and reverse movement in combination with left movement and right movement of the selection device (analogously to a conventional (mechanical) H-bridge).

### SUMMARY OF THE INVENTION

Within the meaning of the present application, an H-bridge operating mode also expressly means an operating mode with more than four gear stages that are adjustable by forward/reverse/left/right movements, wherein more than two side-by-side forward-reverse shift tracks are then present, which can be exited left and/or right in the center.

The present invention addresses a problem of implementing a gear stage selection device for selecting gear stages of a motor vehicle transmission, which is configured so as to be operated in both an automatic operating mode as well as in an H-bridge operating mode and is relatively simply constructed.

The gear stage selection device according to aspects of the invention for selecting gear stages of a motor vehicle transmission is designed so as to be used in conjunction with or as part of a so-called shift-by-wire system, wherein there is no mechanical coupling between the gear stage selection device and the transmission mechanism; rather, electrical signals are transmitted between the gear stage selection device and an actuator coupled to the transmission mechanism. The electronic signals are preferably transmitted via a vehicle bus, for example via a so-called CAN-BUS and/or via the so-called FIBEX standard, or via an Ethernet connection. Typically, the gear stage selection device comprises its own control unit.

The gear stage selection device according to aspects of the invention for selecting gear stages of a motor vehicle transmission comprises a rotatably mounted shaft, which preferably has a circular cross-section. The shaft can be coupled to a rotational spring, a thrust washer, a stepper motor, or another type of actuator in order to generate a defined resistance upon rotation of the shaft.

The gear stage selection device according to aspects of the invention for selecting gear stages of a motor vehicle transmission further comprises a slider apparatus which is displaceable axially, i.e., parallel to an axial direction of the shaft. The slider apparatus can either comprise a slider element that is arranged on the shaft so as to be axially displaceable in relation to the shaft, or the shaft itself can be axially displaceable and can form the slider apparatus or be comprised by the slider apparatus.

The gear stage selection device according to aspects of the invention for selecting gear stages of a motor vehicle transmission further comprises a selection lever coupled to the shaft and the slider apparatus in such a way that, in the case of a forward movement of the selection lever or in the case of a reverse movement of the selection lever, the shaft is rotated axially and, in the case of a left movement of the selection lever or in the case of a right movement of the selection lever, the slider apparatus is displaced axially.

The gear stage selection device according to aspects of the invention for selecting gear stages of a motor vehicle transmission further comprises a rotation angle sensor for detecting a rotation angle of the shaft. The rotation angle sensor can be configured so as to directly detect a current rotation angle of the shaft by way of suitable detection means, or to detect a current rotation angle or a current position of a component coupled to the shaft by way of suitable detection means. The rotation angle sensor is configured so as to output an electrical output signal, for example to a control unit of the gear stage selection device, which indicates the current rotation angle of the shaft or from which the current rotation angle of the shaft can be derived.

The gear stage selection device according to aspects of the invention for selecting gear stages of a motor vehicle transmission further comprises a position sensor for detecting an axial position of the slider apparatus. The position sensor can be configured so as to directly detect the current axial position of the slider apparatus by way of suitable detection means, or to detect a current position or a current location of a component coupled to the slider apparatus by way of suitable detection means. For example, the position sensor can be configured so as to detect by suitable detection means in which of a plurality of locking positions defined by a locking device the slider apparatus is locked. For example, the position sensor can also be configured so as to detect, by suitable detection means, a position of a guide element, which is translationally coupled to the slider apparatus, within a guide link. The position sensor is configured so as to output an electrical output signal which indicates the current position of the slider apparatus or from which the current position of the slider apparatus can be derived, for example to a control unit of the gear stage selection device.

The gear stage selection device according to aspects of the invention for selecting gear stages of a motor vehicle transmission further comprises a blocking apparatus, via which an axial displacement of the slider apparatus and thus the left movement as well as the right movement of the selection lever can be selectively mechanically blocked and released. The rotation of the shaft, or the forward movement and the reverse movement of the selection lever, is not blocked by the blocking apparatus. With the blocking apparatus, as a result, by blocking/releasing the slider apparatus, a shift can easily be made between an automatic operating mode with a single forward-reverse shift track, in which the known automatic gear stages (D, N, R, . . . ) can be selected by forward movement or reverse movement of the selection lever, and an H-bridge operating mode having a plurality of side-by-side forward-reverse shift tracks, in which gear stages indicating individual gears of the vehicle transmission can be selected by forward movement and reverse movement as well as by left and right movement of the selection lever.

The combination of shaft, slider apparatus, selection lever, and blocking apparatus according to aspects of the invention thus allows the implementation of a simply constructed gear stage selection device for selecting gear stages of a motor vehicle transmission that is configured so as to operate in both an automatic operating mode as well as in an H-bridge operating mode.

In a preferred embodiment of the gear stage selection device according to aspects of the invention, the slider apparatus comprises a slider element which is arranged on the shaft so as to be axially displaceable in relation to the shaft, which, for example via a keying or another type of tangential positive locking, is connected to the shaft in a torque-proof manner, and the selection lever is hinged to the slider element in such a way that, in the case of a forward movement or a reverse movement of the selection lever, the slider element and thereby the shaft which is connected to the slider element in a torque-proof manner, and, in the case of left movement or right movement of the selection lever, the slider element is axially displaced in relation to the shaft. This allows for the implementation of a relatively compact gear stage selection device. Preferably, the slider element is mounted on the shaft, i.e., retained by the shaft, in a displaceable manner. However, it is generally also contemplated that the slider element is retained by a separate guide, which is for example formed by a housing. Preferably, the slider element is configured in one piece.

In an alternative embodiment of the gear stage selection device according to aspects of the invention, the shaft is configured so as to be axially displaceable, the slider apparatus comprises the axially displaceable shaft or the slider apparatus is formed by the axially displaceable shaft, and the selection lever is hinged to the shaft in such a way that, in the case of a forward movement or a reverse movement of the selection lever, the shaft is twisted, and in the case of left movement or right movement of the selection lever, the shaft is axially displaced. This allows for the implementation of a gear stage selection device consisting of relatively few individual parts, because a separate slider element is not required.

Preferably, the gear stage selection device according to aspects of the invention comprises a locking device for locking the slider apparatus in at least one locking position. Preferably, the locking device is configured so as to lock the slider apparatus in a plurality of different locking positions. The locking device is preferably configured such that the locking releases on its own when the selection lever is pushed to the left or to the right with a certain degree of force. The locking device is therefore preferably not intended to permanently fix the slider apparatus in a locking position, but rather only to generate a noticeable resistance against a displacement of the slider apparatus out of a locking position.

Preferably, the locking device comprises at least one receptacle arranged on a shell surface of the shaft and an engagement element radially biased against the shaft, wherein the engagement element is configured so as to engage into the at least one receptacle in order to thereby lock the slider apparatus in a locking position. Preferably, the locking device comprises a plurality of receptacles arranged at different axial positions on the shaft for defining a plurality of locking positions. Preferably, the engagement element is a ball that is forced against the shaft by a spring element. The at least one receptacle is formed, in the simplest case, by at least one recess configured in the shell surface of the shaft. However, the at least one receptacle can also be formed by at least one separate receptacle element arranged on the shaft. The at least one receptacle is preferably configured as a circumferentially extending groove of the shaft in order to allow for as unobstructed twisting of the shaft as possible when the slider apparatus is in a locking position.

Generally, the blocking apparatus can be configured in any suitable manner in order to selectively block or release the axial displacement of the slider apparatus. However, in a preferred embodiment of the gear stage selection device according to aspects of the invention, the at least one receptacle of the locking device is formed by at least one radially displaceably arranged receptacle element on the shaft, and the blocking apparatus comprises a blocking mechanism, via which the at least one receptacle element can be pushed against the engagement element in order to block the locking device and thus to block the axial displacement of the slider apparatus. To release the locking device and thus to release the axial displacement of the slider apparatus, the pushing of the at least one receptacle element against the engagement element can be released again.

In a preferred embodiment, the blocking mechanism comprises an eccentric shaft which is arranged rotatably in the shaft, against which a radial inner side of the at least one receptacle element abuts, in such a way that the at least one receptable element can be easily radially moved by twisting the eccentric shaft, in order to selectively push the receptacle element against the engagement element for blocking the locking device and thus for blocking the axial displacement of the slider apparatus, or to release the pushing of the receptacle element against the engagement element for releasing the locking device and thus releasing the axial displacement of the slider apparatus.

In an alternative preferred embodiment, the blocking mechanism comprises an axially displaceable push rod having at least one flank, typically a number of flanks corresponding to the number of receptacle elements, against which a radial inner side of the at least one receptacle element abuts. In this design, the at least one receptable element can be easily radially moved by axial displacement of the push rod, in order to selectively push the receptacle element against the engagement element for blocking the locking device and thus for blocking the axial displacement of the slider apparatus, or to release the pushing of the receptacle element against the engagement element for releasing the locking device and thus releasing the axial displacement of the slider apparatus.

In an alternative preferred embodiment, the blocking apparatus can also comprise a guide link and a guide element, for example pin-shaped, forcibly guided in the guide link, which is translationally, but preferably not rotationally, coupled to the slider apparatus for example via a coupling rod or a coupling bar. The guide link has at least one blocking position in which an axial movement of the guide element through the guide link or through opposite guide surfaces of the guide link is blocked, in such a way that, in the blocking position of the guide link, an axial displacement of the slider apparatus is blocked via the blocking apparatus. The guide link further has at least one release position, in which an axial movement of the guide element through the guide link is released, i.e., the guide element can move axially within the guide link, in such a way that, in the blocking position of the guide link, an axial displacement of the slider apparatus is released via the blocking apparatus. The guide link is configured and arranged in such a way that the at least one blocking position and the at least one release position can be adjusted by moving the guide link in relation to the guide element, for example a sliding and/or twisting of the guide link in relation to the guide element. In the simplest case, the guide link can be configured in a T-shape, for example, wherein one of the two branches of the T-shape guide link is arranged parallel to the axial direction of the shaft and the other is arranged consequently transversely to the axial direction of the shaft. If the guide element is within the branch that extends transversely to the axial direction of the shaft, the axial movement of the guide element is blocked. If the guide element is located at the intersection point of the two branches, then the guide element can be displaced within the branch extending parallel to the axial direction of the shaft in both axial directions. As a result, by moving the guide links transverse to the axial direction of the shaft, the blocking position (guide element within the transverse branch) or the release position (guide element at the intersection point of the two branches) can be adjusted. This allows the implementation of a relatively simple and robust blocking apparatus. By means of suitable configuration and suitable movement of the guide link, a plurality of different operating modes can be provided in a simple manner, in particular also a conventional (mechanical) H-bridge-like H-bridge operating mode, wherein it is clear to a person skilled in the art how the guide link is to be specifically configured and moved in order to implement desired shifting patterns, i.e., desired movement patterns for the selection lever.

In a preferred embodiment, the guide link is formed by a push element that is displaceable in relation to the guide element so that the at least one blocking position and the at least one release position can be adjusted in a simple manner by displacing the guide link. This allows the implementation of a relatively simple and robust blocking apparatus. The push element is configured so as to be displaceable at least transversely to the axial direction of the shaft, but can additionally also be displaceable parallel to the axial direction of the shaft in order to implement more complex shifting patterns or operating concepts.

In an alternative preferred embodiment, the guide link is formed by a rotatable roller element in such a way that the at least one blocking position and the at least one release position can be adjusted in a simple manner by twisting the guide link. This allows the implementation of a relatively simple and robust blocking apparatus. Preferably, the roller element is arranged coaxially to the shaft, i.e., an axis of rotation of the roller element preferably corresponds to an axis of rotation of the shaft. The roller element does not necessarily have to surround the shaft, rather it can also be arranged axially adjacent to the shaft. The roller element also does not necessarily have to have a circular or annular cross-section, but can for example also have a circular segmented or annular segmented cross-section. For example, the roller element can be configured similar to a shift cylinder used in motorcycles in order to shift a sequential transmission. In order to implement more complex shifting patterns or operating concepts, it is also contemplated for the roller element to be additionally displaceable.

Preferably, the guide link has a first release position in which a movement of the guide element is released in both axial directions and at least one further release position in which a movement of the guide element is only released in one of the two axial directions. The first release position serves to implement an H-bridge operating mode, in which the selection lever is moved to the left and to the right in order to select the gear stages, starting from a central neutral position. The further release position is used in order to release a single additional shift track, for example in order to implement a sequential shift operating mode in which gear stages indicating individual gears can be sequentially operated by forward movement and reverse movement of the selection lever.

In principle, the guide link can be moved in any desired manner, for example purely mechanically via a correspondingly configured manual actuation mechanism. Preferably, however, the blocking apparatus comprises an actuator, preferably electromotive, for automated movement of the guide link, so that the movement of the guide link can be controlled by a correspondingly designed control unit. This enables the implementation of particularly complex operating modes, because, for example, after a left movement or a right movement of the selection lever by the actuator, a blocking position can be automatically set. It is further contemplated that, by moving the guide link by means of the actuator, the guide element and thus also the selection lever can be moved automatically, for example in order to automatically move the selection lever into a neutral position or into a defined gear selection position of an H-shift operating mode and/or to generate as authentic a shift feel as possible as part of a force feedback system, for example by mimicking the shifting forces and stops of a mechanical H-bridge and/or by feedback of physical properties of an installed automatic or dual clutch transmission.

In a preferred embodiment, the gear stage selection device according to the present invention comprises an electric motor, for example a so-called servo motor or actuator motor/step motor, whose driven motor rotor is directly or rotationally coupled to the shaft by way of a transmission, in such a way that the shaft can be subjected to a torque by the electric motor, wherein the torque can generally be both a drive torque driving the shaft as well as a braking torque decelerating the shaft. This allows for automated movement of the shaft and thus of the selection lever, for example in order to automatically move the selection lever into a neutral position or into a gear selection position. Furthermore, it is also contemplated to use the electric motor as part of a force feedback system in order to create the most authentic shift feel possible by purposefully driving and braking the shaft. In principle, it is also contemplated that a different type of electromechanical actuator can be used in order to apply torque to the shaft instead of the electric motor, for example, a magnetic/eddy current generating actuator or a magnetorheological actuator.

Preferably, the electric motor comprises a rotation angle sensor or a position sensor for detecting a rotation angle or a position of the motor rotor. Because the motor rotor is rotationally coupled to the shaft, the rotation angle of the motor rotor can also be used in order to directly derive the rotation angle of the shaft, in such a way that the rotation angle sensor or the position sensor of the electric motor can also be used as the rotation angle sensor of the gear stage selection device. In a preferred embodiment, the rotation angle sensor of the gear stage selection device is consequently integrated into the electric motor.

Preferably, the gear stage selection device according to aspects of the invention comprises a spring assembly configured in such a way that the slider apparatus is moved in both axial directions counter to the spring force of a spring element, so that the slider apparatus and thus the selection lever are biased into a central neutral position by the spring assembly. Preferably, the spring assembly comprises at least two spring elements arranged on opposite axial sides of the slider apparatus. A similar effect could also be achieved by way of a suitably configured catch or flow contour.

### BRIEF DESCRIPTION OF THE DRAWINGS

An exemplary embodiment of the present invention is described below with reference to the attached figures. The following is shown in the figures:

FIG. 1 is a schematic diagram of a gear stage selection device according to aspects of the invention for selecting gear stages of a motor vehicle transmission,

FIG. 2 is a schematic diagram of a locking device of the gear stage selection device from FIG. 1,

FIG. 3 is a schematic diagram of an alternative gear stage selection device according to aspects of the invention for selecting gear stages of a motor vehicle transmission,

FIG. 4 depicts an alternative guide link element for the gear stage selection device from FIG. 1 or from FIG. 3,

FIG. 5 is a schematic diagram of an alternative blocking apparatus for the gear stage selection device from FIG. 1 or from FIG. 3, and

FIG. 6 is a schematic diagram of an alternative blocking mechanism for the blocking apparatus from FIG. 5.

### DETAILED DESCRIPTION OF THE INVENTION

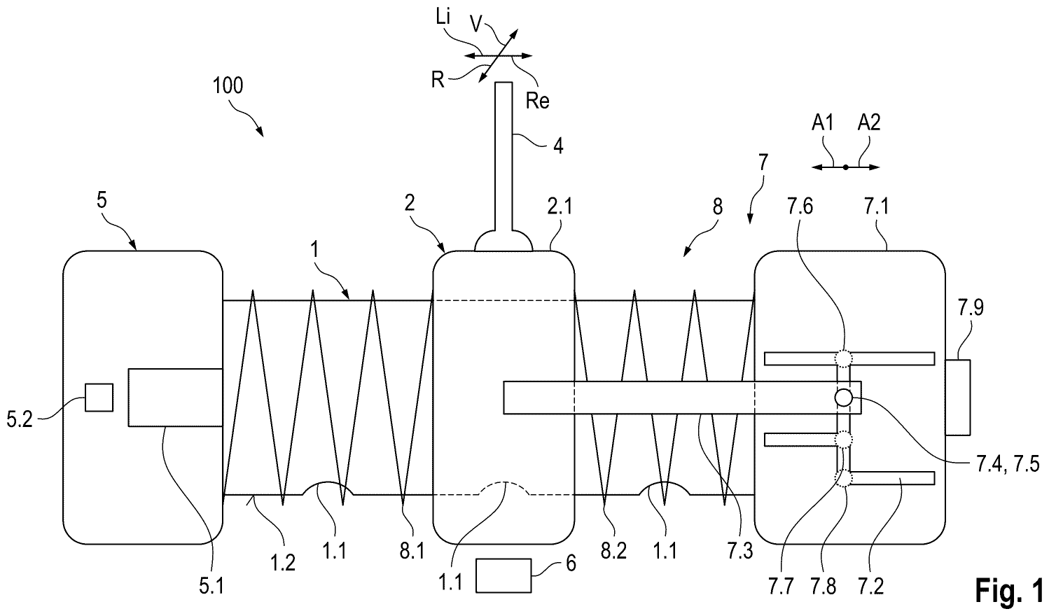

FIG. 1 shows a gear stage selection device 100 according to aspects of the invention for selecting gear stages of a motor vehicle transmission.

The gear stage selection device 100 comprises a rotatable shaft 1 having a plurality of receptacles 1.1, each formed by a recess configured in a shell surface 1.2 of the shaft 1.

The gear stage selection device 100 further comprises a slider apparatus 2 that is arranged on the shaft 1 in a manner so as to be axially displaceable in relation to the shaft 1.

The slider apparatus 2 comprises an annular slider element 2.1, which encloses the shaft 1 and is retained on the shaft 1 in a manner so as to be displaceable axially along the shaft 1.

The slider element 2.1 is coupled to the shaft 1 in a torque-proof manner via a keying formed on an inner peripheral surface of the slider element 2.1 or another type of tangential positive locking.

The slider apparatus 2 comprises an engagement element 2.3 configured as a ball, which is arranged in a radially displaceable manner in a recess 2.1.1 of the slider element 2.1 and is biased against the shaft 1 via a spring element 2.4.

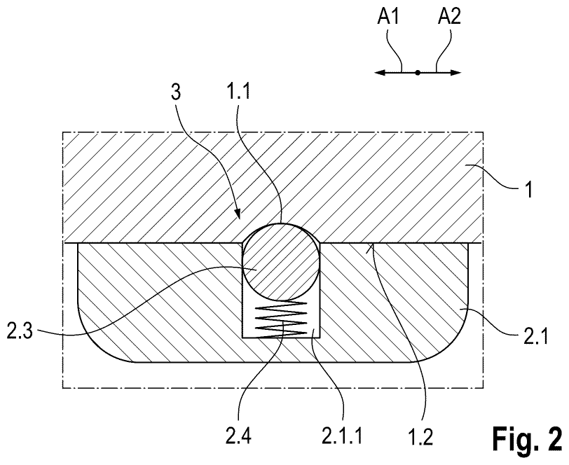

The engagement element 2.3 and the receptacles 1.1 arranged on the shaft 1 form a locking device 3 for locking the slider apparatus 2 in a plurality of locking positions defined by the receptacles 1.1 arranged on the shaft 1, wherein the engagement element 2.3 is configured as shown in FIG. 2 so as to engage into one of the respective receptacles 1.1 arranged on the shaft 1 in the locking positions.

The gear stage selection device 100 further comprises a selection lever 4 that is hinged to the slider element 2.1 in such a way that, in the case of a forward movement of the selection lever 4, i.e., a movement of the selection lever 4 in a forward direction V, or in the case of a reverse movement of the selection lever 4, i.e., a movement of the selection lever 4 in a reverse direction R, the slider element 2.1 and consequently also the shaft 1 are twisted, and, in the case of a left movement of the selection lever 4, i.e., a movement of the selection lever 4 in a left direction Li, or in a right movement of the selection lever 4, i.e., a movement of the selection lever 4 in a right direction Re, the slider apparatus 2 is axially displaced in relation to the shaft 1.

The gear stage selection device 100 further comprises an electric motor 5 arranged at an end of the shaft 1 whose driven motor rotor 5.1 is connected to the shaft 1 in a torque-proof manner.

The electric motor 5 comprises a rotation angle sensor 5.2 configured so as to detect a current rotation angle of the motor rotor 5.1, and thus also a current rotation angle of the shaft 1 which is coupled to the motor rotor 5.1 in a torque-proof manner.

The gear stage selection device 100 further comprises a position sensor 6 configured so as to detect a current axial position of the slider apparatus 2.

The gear stage selection device 100 further comprises a blocking apparatus 7, via which the axial displacement of the slider apparatus 2 can be selectively mechanically blocked and released.

The blocking apparatus 7 comprises a guide link element 7.1, which is configured either as a push element that is transversely displaceable in relation to the shaft 1 or as a rotatable roller element that is arranged coaxially in relation to the shaft 1.

The guide link element 7.1 forms a guide link 7.2 in which a pin-shaped guide element 7.4, which is translationally but not rotationally coupled to the slider element 2.1 of the slider apparatus 2 by way of a coupling rod 7.3, is forcibly guided.

The guide link 7.2 has a blocking position 7.5, a first release position 7.6, a second release position 7.7, and a third release position 7.8, which are shown in FIG. 1 by the respective position of the guide element 7.4 within the guide link 7.2.

In the blocking position 7.5, an axial movement of the guide element 7.4, i.e., a movement of the guide element 7.4 in a first axial direction A1 as well as in a second axial direction A2 through the guide link 7.2, is blocked.

In the first release position 7.6, an axial movement of the guide element 7.4 in both axial directions A1, A2 is released; in the second release position 7.7, an axial movement of the guide element 7.4 is only released in the first axial direction A1; and in the third release position 7.8, an axial movement of the guide element 7.4 is only released in the second axial direction A2.

The blocking position 7.5 as well as the three release positions 7.6-7.8 can be adjusted by a movement of the guide link element 7.1 and thus the guide link 7.2, wherein a guide link element 7.1 configured as a push element is displaced transversely to the shaft 1 for adjusting the blocking position 7.5 as well as the three release positions 7.6-7.8, and a guide link element 7.1 configured as a roller element is twisted in relation to the shaft 1 for adjusting the blocking position 7.5 as well as the three release positions 7.6-7.8.

The blocking apparatus 7 further comprises an actuator 7.9 for automated movement of the guide link element 7.1 and thus the guide link 7.2.

The gear stage selection device 100 further comprises a spring assembly 8 having a first spring element 8.1 arranged between the slider apparatus 2 and the electric motor 5 and having a second spring element 8.2 arranged between the slider apparatus 2 and the guide link element 7.1.

The slider apparatus 2 is consequently moved in the first axial direction A1 counter to the spring force of the first spring element 8.1 and in the second axial direction A2 counter to the spring force of the second spring element 8.2.

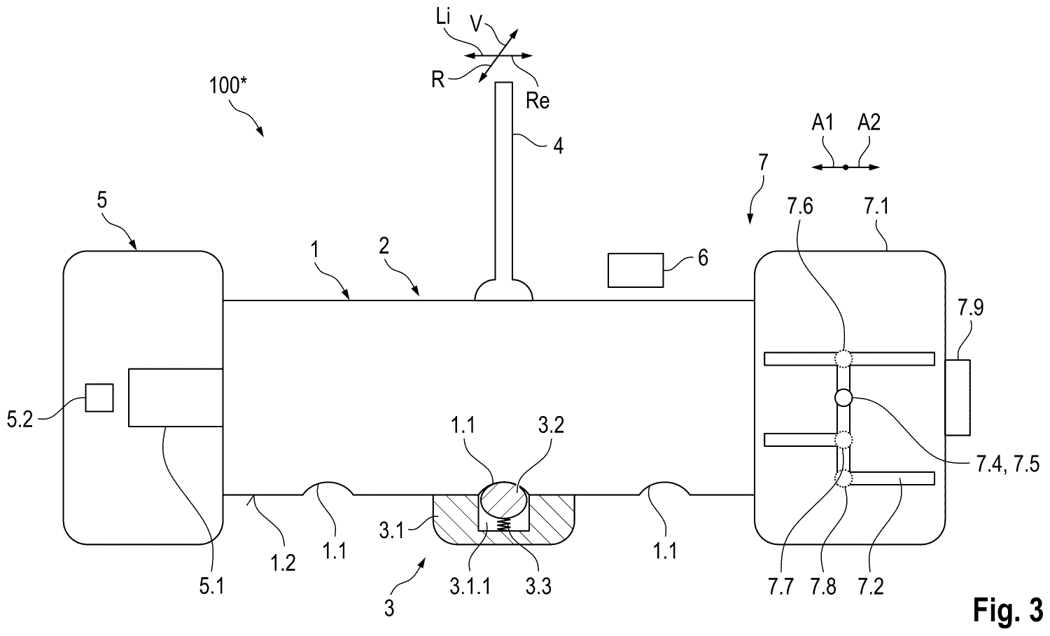

FIG. 3 shows an alternative gear stage selection device 100* according to aspects of the invention for selecting gear stages of a motor vehicle transmission, wherein features that are identical or similarly known from the gear stage selection device 100 use the corresponding reference numerals from FIG. 1 and FIG. 2.

The gear stage selection device 100* differs from the gear stage selection device 100 substantially in that the shaft 1 is configured so as to be axially displaceable and the slider apparatus 2 is substantially formed by the axially displaceable shaft 1, and consequently no axially displaceable slider element 2.1 is present in the gear stage selection device 100*.

With the gear stage selection device 100*, the position sensor 6 is configured so as to detect a current axial position of the shaft 1, i.e., the slider apparatus 2, and the guide element 7.4, which is forcibly guided in the guide link 7.2, is translationally but not rotationally coupled to the shaft 1.

Furthermore, in the gear stage selection device 100*, the spring assembly is configured in such a way that the slider apparatus 2 formed by the shaft 1 is moved in the first axial direction A1 counter to the spring force of the first spring element and in the second axial direction A2 counter to the spring force of the second spring element (not shown).

Furthermore, in the gear stage selection device 100*, the locking device 3 comprises a fixed part 3.1 having a recess 3.1.1 into which an engagement element 3.2, which is configured as a ball, is radially displaceable and is arranged so as to be biased against the shaft 1 via a spring element 3.3, in such a way that the engagement element 3.2 engages into one of the respective receptacles 1.1 arranged on the shaft 1 in the locking positions.

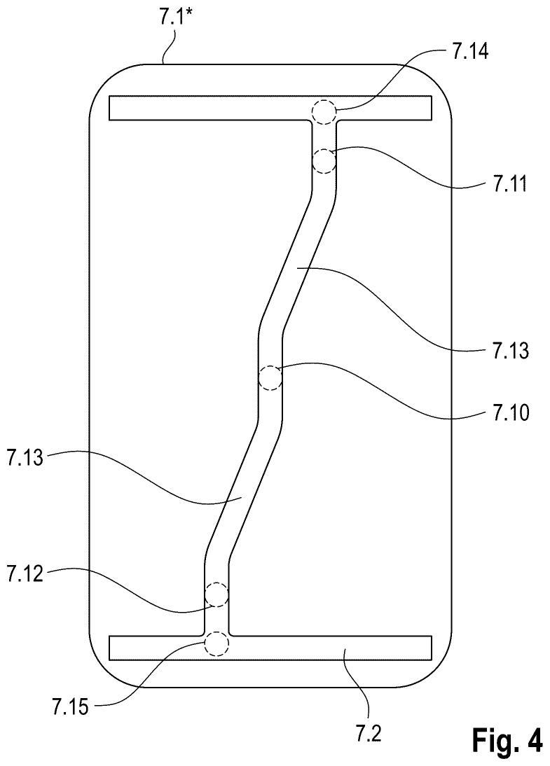

FIG. 4 illustrates an alternative guide link element 7.1* for the gear stage selection device 100 or for the gear stage selection device 100*, wherein features that are identical or similarly known from the guide link element 7.1 use the corresponding reference numerals from FIG. 1 to FIG. 3.

The guide link 7.2 of the guide link element 7.1* has a central blocking position 7.10, a first lateral blocking position 7.11, and a second lateral blocking position 7.12, wherein the guide element 7.4 forcibly guided in the guide link 7.2 and thus the slider apparatus is blocked by the three blocking positions 7.10, 7.11, 7.12 at different axial positions.

The three blocking positions 7.10, 7.11, 7.12 are connected to each other by diagonally extending guide link sections 7.13, which allow the guide element 4 and thus the slider apparatus 2 to reliably move in an axial manner by the movement of the guide link element 7.1*.

The guide link 7.2 of the guide link element 7.1* further comprises a first release position 7.14 and a second release position 7.15, in which a respective axial movement of the guide element 7.4 in both axial directions A1, A2 is released.

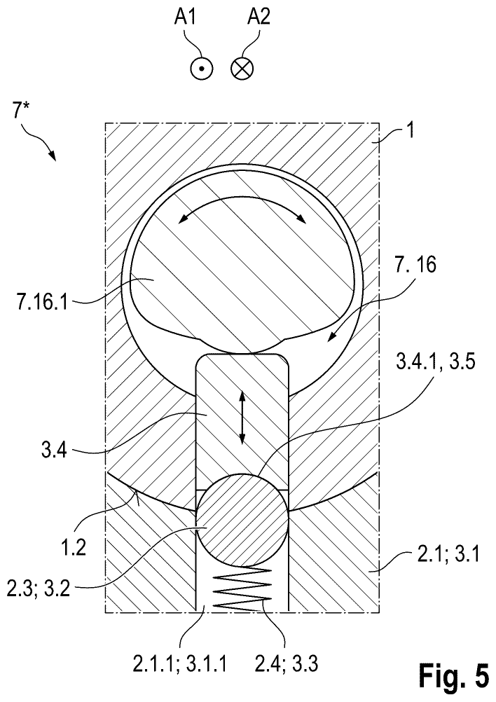

FIG. 5 illustrates an alternative blocking apparatus 7* for the gear stage selection device 100 or for the gear stage selection device 100*, wherein features that are identical or similarly known from the blocking apparatus 7 use the corresponding reference numerals from FIG. 1 to FIG. 4.

The blocking apparatus 7* differs from the blocking apparatus 7 substantially in that, instead of the guide link 7.2 and the guide element 7.4, there is a blocking mechanism 7.16 for blocking the locking device 3, wherein the blocking mechanism 7.16 can be used with both the locking device 3 of the gear stage selection device 100 as shown in FIG. 2 and the locking device 3 of the gear stage selection device 100* as shown in FIG. 3, for which reason the reference numerals of both designs of the locking device 3 are provided below as well as in FIG. 5 for features of locking device 3.

The locking device 3 comprises a plurality of receptacle elements 3.4 that are arranged in the shaft 1 in a radially displaceable manner, each having a recess 3.4.1 on its radially outer side, which form a receptacle 3.5 of the locking device 3.

The blocking mechanism 7.16 comprises an eccentric shaft 7.16.1 arranged rotatably in the shaft 1, against which a radial inner side of the receptacle elements 3.4 abuts, in such a way that, by twisting the eccentric shaft 7.16.1, the corresponding receptacle element 3.4 can selectively be pushed against the engagement element 2.3; 3.2 for blocking the locking device 3 and thus for blocking the axial displacement of the slider apparatus 2, or the pushing of the receptacle element 3.4 against the engagement element 2.3; 3.2 can be released for releasing the locking device 3 and thus releasing the axial displacement of the slider apparatus 2.

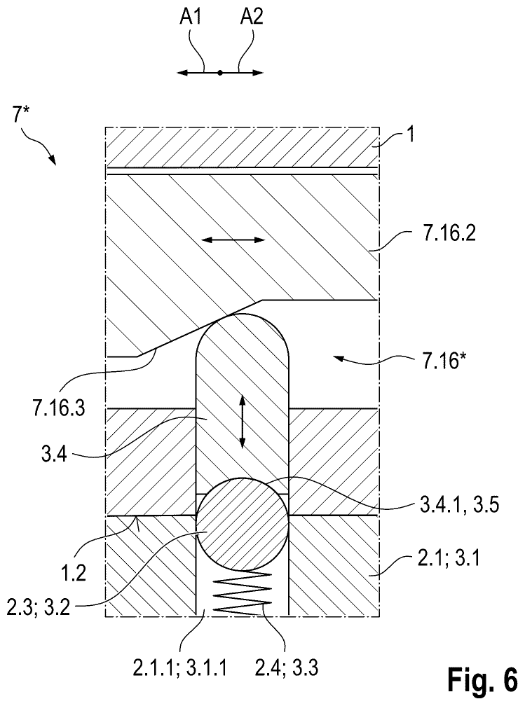

FIG. 6 illustrates an alternative blocking mechanism 7.16* for the blocking apparatus 7*, wherein features that are identical or similarly known from the blocking mechanism 7.16 use the corresponding reference numerals from FIG. 5.

The blocking mechanism 7.16* differs from the blocking mechanism 7.16 in that, instead of the eccentric shaft 7.16.1, there is an axially displaceable push rod 7.16.2 having a number of flanks 7.16.3 corresponding to the number of receptacle elements 3.4, wherein the radial inner side of one of the receptacle elements 3.4 abuts against each of the flanks 7.16.3. By axial sliding of the push rod 7.16.2, the corresponding receptacle element 3.4 can consequently selectively be pushed against the engagement element 2.3; 3.2 for blocking the locking device 3 and thus for blocking the axial displacement of the slider apparatus 2, or the pushing of the receptacle element 3.4 against the engagement element 2.3; 3.2 can be released for releasing the locking device 3 and thus releasing the axial displacement of the slider apparatus 2.

### LIST OF REFERENCE NUMERALS

100; 100* Gear stage selection device
1 Shaft
1.1 Receptacles
1.2 Shell surface
2 Slider apparatus
2.1 Slider element
2.1.1 Recess
2.3 Engagement element
2.4 Spring element
3 Locking device
3.1 Fixed part
3.1.1 Recess
3.2 Engagement element
3.3 Spring element
3.4 Receptacle elements
3.4.1 Recess
3.5 Receptacle
4 Selection lever
5 Electric motor
5.1 Motor rotor
5.2 Rotation angle sensor
6 Position sensor
7; 7* Blocking apparatus
7.1; 7.1* Guide link element
7.2 Guide link
7.3 Coupling rod
7.4 Guide element
7.5 Blocking position
7.6 First release position
7.7 Second release position
7.8 Third release position
7.9 Actuator
7.10 Central blocking position
7.11 First lateral blocking position
7.12 Second lateral blocking position
7.13 Diagonally extending guide link sections
7.14 First release position
7.15 Second release position
7.16; 7.16* Blocking mechanism
7.16.1 Eccentric shaft
7.16.2 Push rod
7.16.3 Flanks
8 Spring assembly
8.1 First spring element
8.2 Second spring element
A1 First axial direction
A2 Second axial direction
Li Left direction
R Reverse direction
Re Right direction
V Forward direction

What is claimed is:

1. A gear stage selection device for selecting gear stages of a motor vehicle transmission, said gear stage selection device comprising:
a shaft,
an axially displaceable slider apparatus,
a selection lever, which is coupled to the shaft and the slider apparatus in such a way that (i) in a case of a forward movement of the selection lever or in a case of a reverse movement of the selection lever, the shaft twists, and (ii) in a case of a left movement of the selection lever or a right movement of the selection lever, the slider apparatus moves in an axial direction,
a rotation angle sensor for detecting a rotation angle of the shaft,
a position sensor for detecting an axial position of the slider apparatus, and
a blocking apparatus for selectively and mechanically blocking and releasing an axial displacement of the slider apparatus.

2. The gear stage selection device according to claim 1, wherein:
the slider apparatus comprises a slider element which is arranged on the shaft so as to be axially displaceable in relation to the shaft and is connected to the shaft in a torque-proof manner, and
the selection lever is hinged to the slider element.

3. The gear stage selection device according to claim 1, wherein:
the shaft is arranged in an axially displaceable manner,
the slider apparatus comprises the shaft, and
the selection lever is hinged to the shaft.

4. The gear stage selection device according to claim 1, further comprising a locking device for locking the slider apparatus in at least one locking position.

5. The gear stage selection device according to claim 4, wherein the locking device comprises at least one receptacle arranged on a shell surface of the shaft and an engagement element which is radially biased against the shaft, wherein the engagement element is configured to engage into the at least one receptacle.

6. The gear stage selection device according to claim 5, wherein the at least one receptacle is formed by at least one radially displaceable receptacle element, and wherein the blocking apparatus comprises a blocking mechanism via which the at least one receptacle element can be pushed against the engagement element so as to block the locking device.

7. The gear stage selection device according to claim 6, wherein the blocking mechanism comprises an eccentric shaft which is rotatably arranged in the shaft, against which a radially inner side of the at least one receptacle element abuts.

8. The gear stage selection device according to claim 6, wherein the blocking mechanism comprises an axially displaceable push rod having at least one flank against which a radially inner side of the at least one receptacle element abuts.

9. The gear stage selection device according to claim 1, wherein the blocking apparatus comprises a guide link and a guide element which is forcibly guided in the guide link, wherein the guide element is translationally coupled to the slider apparatus, wherein the guide link comprises at least one blocking position, in which an axial movement of the guide element through the guide link is blocked, wherein the guide link has at least one release position, in which an axial movement of the guide element through the guide link is released, and wherein the at least one blocking position and the at least one release position are configured to be adjusted by a movement of the guide link.

10. The gear stage selection device according to claim 9, wherein the guide link is formed by a displaceable push element, and wherein the at least one blocking position and the at least one release position are adjusted by a displacement of the guide link.

11. The gear stage selection device according to claim 9, wherein the guide link is formed by a twistable roller element, and wherein the at least one blocking position and the at least one release position are adjusted by a twisting of the guide link.

12. The gear stage selection device according to claim 9, wherein, in a first release position, a movement of the guide element is released in two axial directions, and, in a further release position, a movement of the guide element is released only in one of the two axial directions.

13. The gear stage selection device according to claim 9, wherein the blocking apparatus comprises an actuator for automated movement of the guide link.

14. The gear stage selection device according to claim 1, further comprising an electric motor that is rotationally coupled to the shaft.

15. The gear stage selection device according to claim 14, wherein the rotation angle sensor is integrated into the electric motor.

16. The gear stage selection device according to claim 1, further comprising a spring assembly configured in such a way that the slider apparatus is moved in two axial directions counter to a spring force of a respective spring element.

17. A motor vehicle comprising the gear stage selection device of claim 1.
